(19) United States
(12) Patent Application Publication
(10) Pub. No.: US 2016/0209513 A1
(43) Pub. Date: Jul. 21, 2016

(54) ELECTRONIC APPARATUS

(71) Applicant: KYOCERA Corporation, Kyoto-shi (JP)

(72) Inventors: Masahiko HIRAHAMA, Kawanishi-shi (JP); Takashi YAMADA, Tokyo (JP)

(21) Appl. No.: 15/081,643

(22) Filed: Mar. 25, 2016

Related U.S. Application Data
(63) Continuation of application No. PCT/JP2014/075524, filed on Sep. 25, 2014.

(30) Foreign Application Priority Data
Sep. 26, 2013 (JP) 2013-200191

(51) Int. Cl. G01S 19/36; H01Q 21/30

(52) U.S. Cl. CPC G01S 19/36; H01Q 21/30

(57) ABSTRACT

An electronic apparatus comprises a first receiving antenna that receives a signal from a satellite in a satellite positioning system, a multi-antenna including a second receiving antenna, and a first feeding point shared by the first and second receiving antennas. The first receiving antenna is located nearer to a corner of the electronic apparatus than the second receiving antenna is.

### CROSS-REFERENCE TO RELATED APPLICATION

The present application is a continuation based on PCT Application No. PCT/JP2014/075524, filed on Sep. 25, 2014, which claims the benefit of Japanese Application No. 2013-200191, filed on Sep. 26, 2013. PCT Application No. PCT/JP2014/075524 is entitled “ELECTRONIC DEVICE,” and Japanese Application No. 2013-200191 is entitled “ELECTRONIC APPARATUS.” The contents of which are incorporated by reference herein in their entirety.

### FIELD

Embodiments of the present disclosure relate to an electronic apparatus.

### BACKGROUND

Various technologies have conventionally been proposed for electronic apparatuses.

### SUMMARY

An electronic apparatus is disclosed. In one embodiment, an electronic apparatus comprises a first receiving antenna that receives a signal from a satellite in a satellite positioning system, a multi-antenna including a second receiving antenna, and a first feeding point shared by the first and second receiving antennas. The first receiving antenna is located nearer to a corner of the electronic apparatus than the second receiving antenna is.

### BRIEF DESCRIPTION OF THE DRAWINGS

FIG. 1 illustrates a perspective view showing an external appearance of an electronic apparatus according an embodiment 1.

FIG. 2 illustrates a rear view showing the external appearance of the electronic apparatus according to the embodiment 1.

FIG. 3 illustrates a configuration of a wireless processing executor according to the embodiment 1.

FIG. 4 illustrates structures of various antennas and a battery-side case body according to the embodiment 1.

FIG. 5 illustrates a rear view showing the external appearance of the electronic apparatus according to the embodiment 1.

FIG. 6 illustrates a partially enlarged view showing a battery-side case body according to the embodiment 1.

FIG. 7 illustrates a configuration of a wireless processing executor according to an embodiment 2.

FIG. 8 illustrates structures of various antennas and a battery-side case body according to the embodiment 2.

FIG. 9 illustrates a partially-enlarged view showing the battery-side case body according to the embodiment 2.

### DETAILED DESCRIPTION

### Embodiment 1

### <Structure of External Appearance of Electronic Apparatus>

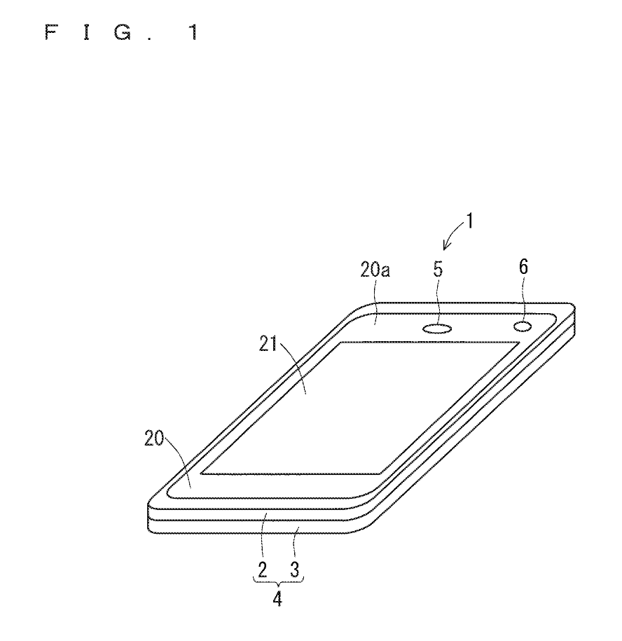

FIG. 1 is a perspective view showing the outline of an external appearance of an electronic apparatus 1 according to an embodiment 1. The electronic apparatus 1 is, for example, a mobile phone, such as a smartphone.

As illustrated in FIG. 1, the electronic apparatus 1 comprises an apparatus case 4 including a display-side case 2 and a battery-side case 3. The display-side case 2 and the battery-side case 3 are combined, and thus the electronic apparatus 1 (the apparatus case 4) has an approximately rectangular plate shape in a plan view.

Provided on an outer surface 20 of the display-side case 2, in other words, on a front surface of the apparatus case 4 is a transparent display region 21. The user can visually recognize, through the display region 21, a variety of information including characters displayed on the display located in the apparatus case 4 such as a liquid crystal display. Provided in an upper edge portion 20a of the outer surface 20 of the display-side case 2 is a receiver hole 5. The apparatus case 4 includes a receiver, and thus the receiver outputs received sound to the outside of the electronic apparatus 1 through the receiver hole 5. A camera lens 6 located in the apparatus case 4 can be visually recognized from the upper edge portion 20a of the outer surface 20 of the display-side case 2.

The upper side and the lower side refer to the upper side and the lower side of the electronic apparatus 1 assuming that the user holding the electronic apparatus 1 in a hand sets the electronic apparatus 1 to the ear to have a telephone conversation. During a telephone conversation, the user generally holds the electronic apparatus 1 in a hand with the portion having the receiver hole 5 being the upper side, and thus the part of the electronic apparatus 1 having the receiver hole 5 is referred to as the upper side.

The apparatus case 4 accommodates various components other than the display, the receiver, and the camera lens 6. The apparatus case 4 accommodates, for example, a printed circuit board with electronic components mounted thereon, a metal plate that strengthens the apparatus case 4, and a battery.

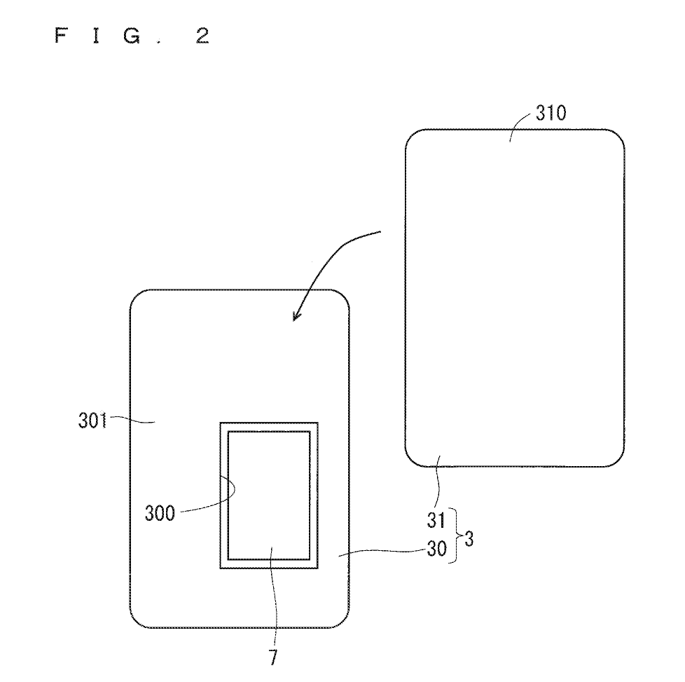

FIG. 2 illustrates a plan view showing the outline of the external appearance of the electronic apparatus 1 when seen from the rear surface side thereof.

The battery-side case 3 comprises a battery-side case body 30 and a cover member 31. The battery-side case body 30 accommodates a battery 7 and is fitted to the display-side case 2. The cover member 31 is fitted to the battery-side case body 30 from the rear surface side of the electronic apparatus 1. FIG. 2 illustrates the battery-side case 3 with the cover member 31 being detached from the battery-side case body 30.

The cover member 31 is fitted to the battery-side case body 30 so as to cover an outer surface 301 of the battery-side case body 30. An outer surface 310 of the cover member 31 becomes the rear surface of the electronic apparatus 1 (the rear surface of the apparatus case 4). Provided in the battery-side case body 30 is an opening 300. The battery 7 is accommodated in the battery-side case body 30 through the opening 300. When the cover member 31 is fitted to the battery-side case body 30, the battery 7 exposed from the battery-side case body 30 is covered with the cover member 31. The user detaches the cover member 31 from the battery-side case body 30 to replace the battery 7.

### <Configuration of Wireless Processing Executor>

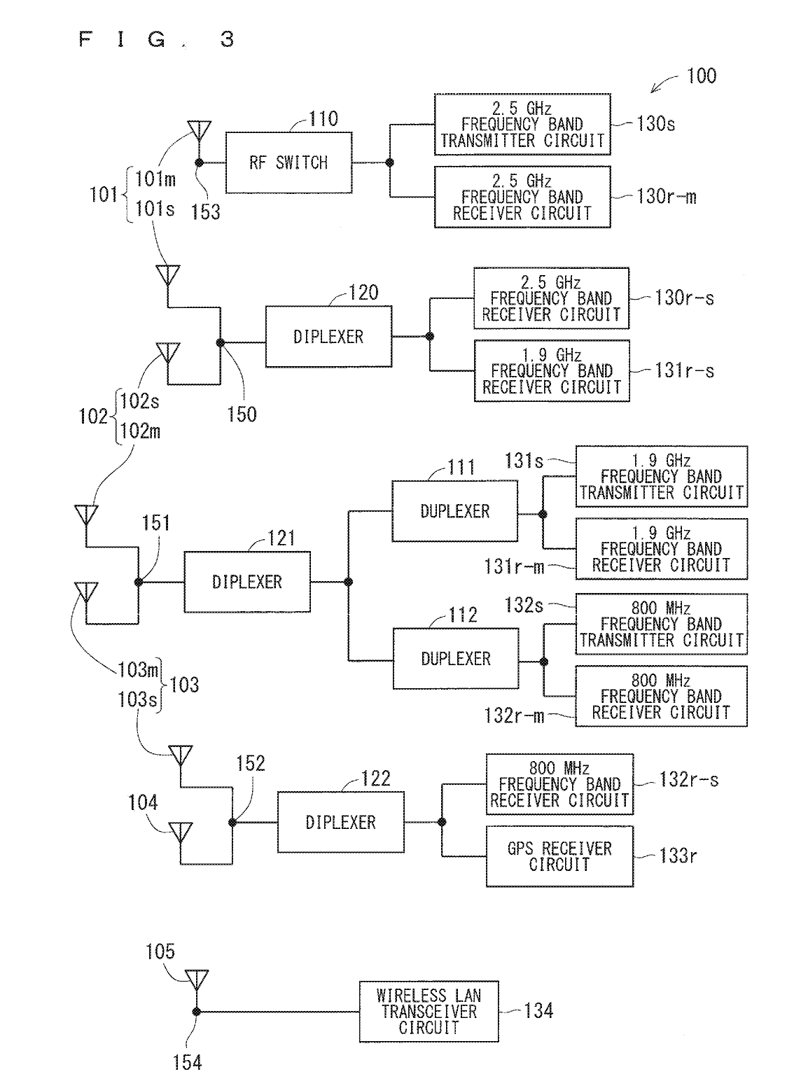

The electronic apparatus 1 includes a wireless processing executor 100 that can perform wireless communication with other communication apparatuses. FIG. 3 illustrates a configuration of the wireless processing executor 100. The wireless processing executor 100 can perform wireless communication with a base station through the use of wireless signals in the 2.5 GHz frequency band, the 1.9 GHz frequency band, and the 800 MHz frequency band. In one embodiment, the wireless processing executor 100 can transmit and receive wireless signals in the 2.5 GHz frequency band, the 1.9 GHz frequency band, and the 800 MHz frequency band in the Long Term Evolution (LTE) as well as wireless signals in the 1.9 GHz frequency band and the 800 MHz frequency band in the Code Division Multiple Access (CDMA). The wireless processing executor 100 can receive wireless signals from a satellite in the satellite positioning system, such as the Global Positioning System (GPS). The wireless processing executor 100 can perform wireless communication with a communication apparatus through a wireless LAN, such as WiFi. The wireless signals from a GPS satellite are hereinafter referred to as “GPS signals.”

As illustrated in FIG. 3, the wireless processing executor 100 includes a first antenna group 101 that can transmit and receive wireless signals in the 2.5 GHz frequency band, a second antenna group 102 that can transmit and receive wireless signals in the 1.9 GHz frequency band, and a third antenna group 103 that can transmit and receive wireless signals in the 800 MHz frequency band. The first antenna group 101 can transmit and receive wireless signals in the 2.5 GHz frequency band referred to as “B41” in LTE. The second antenna group 102 can transmit and receive wireless signals in the 1.9 GHz frequency band referred to as “B25” in LTE and wireless signals in the 1.9 GHz frequency band referred to as “BC1” in CDMA. The third antenna group 103 can transmit and receive wireless signals in the 800 MHz frequency band referred to as “B26” in LTE, wireless signals in the 800 MHz frequency band referred to as “BC0” in CDMA, and wireless signals in the 800 MHz frequency band referred to as “BC10” in CDMA.

The wireless processing executor 100 includes a GPS antenna 104 that can receive GPS signals and a wireless LAN antenna 105 that can transmit and receive wireless signals in a wireless LAN. GPS signals are wireless signals in the 1.5 GHz frequency band. Wireless signals transmitted and received by the wireless LAN antenna, or equivalently, wireless signals in WiFi in one example, are wireless signals in the 2.4 GHz frequency band.

The first antenna group 101 in the 2.5 GHz frequency band includes a main antenna 101m that can perform transmission and reception and a sub-antenna 101s that can perform only reception. The first antenna group 101 performs transmission only through the main antenna 101m and performs reception through the main antenna 101m and the sub-antenna 101s. That is, the first antenna group 101 functions as a multi-antenna only during reception.

The second antenna group 102 in the 1.9 GHz frequency band includes a main antenna 102m that can perform transmission and reception and a sub-antenna 102s that can perform only reception. Similarly to the first antenna group 101, the second antenna group 102 performs transmission only through the main antenna 102m and performs reception through the main antenna 102m and the sub-antenna 102s. That is, the second antenna group 102 functions as a multi-antenna only during reception.

The third antenna group 103 includes a main antenna 103m that can perform transmission and reception and a sub-antenna 103s that can perform only reception. Similarly to the first antenna group 101 and the second antenna group 102, the third antenna group 103 performs transmission only through the main antenna 103m and performs reception through the main antenna 103m and the sub-antenna 103s. That is, the third antenna group 103 functions as a multi-antenna only during reception.

In one embodiment, each of the first antenna group 101, the second antenna group 102, and the third antenna group 103 is used as a Multiple Input Multiple Output (MIMO) receiving multi-antenna that receives MIMO signals from a base station during reception.

At least one of the first antenna group 101, the second antenna group 102, and the third antenna group 103 may be used as a multi-antenna other than the MIMO multi-antenna. For example, at least one of the first antenna group 101, the second antenna group 102, and the third antenna group 103 may be used as an adaptive array multi-antenna that controls at least one of the antenna-directional beam and null. Furthermore, at least one of the first antenna group 101, the second antenna group 102, and the third antenna group 103 may be used as a diversity multi-antenna.

In one embodiment, the sub-antenna 101s in the 2.5 GHz frequency band and the sub-antenna 102s in the 1.9 GHz frequency band share a feeding point 150. The main antenna 102m in the 1.9 GHz frequency band and the main antenna 103m in the 800 MHz frequency band share a feeding point 151. The sub-antenna 103s in the 800 MHz frequency band and the GPS antenna 104 (the antenna in the 1.5 GHz frequency band) share a feeding point 152. A feeding point 153 for the main antenna 101m in the 2.5 GHz frequency band is not shared with another antenna. A feeding point 154 for the wireless LAN antenna 105 is not shared with another antenna.

The wireless processing executor 100 includes a 2.5 GHz frequency band transmitter circuit 130s, a 1.9 GHz frequency band transmitter circuit 131s, an 800 MHz frequency band transmitter circuit 132s, and a wireless LAN transceiver circuit 134.

The wireless processing executor 100 further includes two 2.5 GHz frequency band receiver circuits, namely 2.5 GHz frequency band receiver circuits 130r-m and 130r-s, two 1.9 GHz frequency band receiver circuits, namely 1.9 GHz frequency band receiver circuits 131r-m and 131r-s, two 800 MHz frequency band receiver circuits, namely 800 MHz frequency band receiver circuits 132r-m and 132r-s, and a GPS receiver circuit 133r.

The wireless processing executor 100 further includes an RF switch (a high-frequency switch) 110, two duplexers, namely duplexers 111 and 112, and three diplexers, namely diplexers 120, 121, and 122. The RF switch 110 is connected with the feeding point 153 for the main antenna 101m in the 2.5 GHz frequency band and the diplexer 120 is connected with the feeding point 150 for the sub-antenna 101s in the 2.5 GHz frequency band and the sub-antenna 102s in the 1.9 GHz frequency band. The diplexer 121 is connected with the feeding point 151 for the main antenna 102m in the 1.9 GHz frequency band and the main antenna 103m in the 800 MHz frequency band. The diplexer 122 is connected with the feeding point 152 for the GPS antenna 104 and the sub-antenna 103s in the 800 MHz frequency band.

### <Transmission Processing>

Transmission signals generated by a controller (not shown) that controls the wireless processing executor 100 are input to the 2.5 GHz frequency band transmitter circuit 130s, the 1.9 GHz frequency band transmitter circuit 131s, the 800 MHz frequency band transmitter circuit 132s, and the wireless LAN transceiver circuit 134. The 2.5 GHz frequency band transmitter circuit 130s performs up conversion, an amplification processing, and the like on the input transmission signals to generate transmission signals in the 2.5 GHz frequency band. The transmission signals generated by the 2.5 GHz frequency band transmitter circuit 130s are input to the main antenna 101m through the RF switch 110. The main antenna 101m transmits wireless signals in the 2.5 GHz frequency band accordingly.

The 1.9 GHz frequency band transmitter circuit 131s performs up conversion, an amplification processing, and the like on the input transmission signals to generate transmission signals in the 1.9 GHz frequency band. The transmission signals in the 1.9 GHz frequency band are input to the main antenna 102m through the duplexer 111 and the diplexer 121. The main antenna 102m transmits wireless signals in the 1.9 GHz frequency band accordingly.

The 800 MHz frequency band transmitter circuit 132s performs up conversion, an amplification processing, and the like on the input transmission signal to generate transmission signals in the 800 MHz frequency band. The transmission signals in the 800 MHz frequency band are input to the main antenna 103m through the duplexer 112 and the diplexer 121. The main antenna 103m transmits wireless signals in the 800 MHz frequency band accordingly.

The wireless LAN transceiver circuit 134 performs up conversion, an amplification processing, and the like on the input transmission signals to generate transmission signals in the 2.4 GHz frequency band. The transmission signals in the 2.4 GHz frequency band are input to the wireless LAN antenna 105. The wireless LAN antenna 105 transmits wireless signals in the 2.4 GHz frequency band in WiFi accordingly.

### <Reception Processing>

Reception signals received by the main antenna 101m in the 2.5 GHz frequency band are input to the 2.5 GHz frequency band receiver circuit 130r-m through the RF switch 110. The 2.5 GHz frequency band receiver circuit 130r-m performs an amplification processing, down conversion, and the like on the input reception signals, and outputs the processed reception signals to the controller. Reception signals received by the sub-antenna 101s are input to the 2.5 GHz frequency band receiver circuit 130r-s through the diplexer 120. The 2.5 GHz frequency band receiver circuit 130r-s performs an amplification processing, down conversion, and the like on the input reception signals, and outputs the processed reception signals to the controller. The controller performs a demodulation processing and the like on the reception signals output from the 2.5 GHz frequency band receiver circuits 130r-m and 130r-s to reproduce control data, user data, and the like included in wireless signals in the 2.5 GHz frequency band transmitted by the base station.

Reception signals received by the sub-antenna 102s in the 1.9 GHz frequency band are input to the 1.9 GHz frequency band receiver circuit 131r-s through the diplexer 120. The 1.9 GHz frequency band receiver circuit 131r-s performs an amplification processing, down conversion, and the like on the input reception signals, and outputs the processed signals to the controller. Reception signals received by the main antenna 102m in the 1.9 GHz frequency band are input to the 1.9 GHz frequency band receiver circuit 131r-m through the diplexer 121 and the duplexer 111. The 1.9 GHz frequency band receiver circuit 131r-m performs an amplification processing, down conversion, and the like on the input reception signals, and outputs the processed reception signals to the controller. The controller performs a demodulation processing and the like on the reception signals output from the 1.9 GHz frequency band receiver circuits 131r-m and 131r-s to reproduce control data, user data, and the like included in wireless signals in the 1.9 GHz frequency band transmitted by the base station.

Reception signals received by the main antenna 103m in the 800 MHz frequency band are input to the 800 MHz frequency band receiver circuit 132r-m through the diplexer 121 and the duplexer 112. The 800 MHz frequency band receiver circuit 132r-m performs an amplification processing, down conversion, and the like on the input reception signals, and outputs the processed reception signals to the controller. Reception signals received by the sub-antenna 103s in the 800 MHz frequency band are input to the 800 MHz frequency band receiver circuit 132r-s through the diplexer 122. The 800 MHz frequency band receiver circuit 132r-s performs an amplification processing, down conversion, and the like on the input reception signals, and outputs the processed reception signals to the controller. The controller performs a demodulation processing and the like on the reception signals output from the 800 MHz frequency band receiver circuits 132r-m and 132r-s to reproduce control data, user data, and the like included in wireless signals in the 800 MHz frequency band transmitted by the base station.

Reception signals received by the GPS antenna 104 are input to the GPS receiver circuit 133r through the diplexer 122. The GPS receiver circuit 133r performs an amplification processing, down conversion, and the like on the input reception signals, and outputs the processed reception signals to the controller. The controller performs a demodulation processing and the like on the reception signals input from the GPS receiver circuit 133r to reproduce control data, user data, and the like included in the reception signals.

Reception signals received by the wireless LAN antenna 105 are input to the wireless LAN transceiver circuit 134. The wireless LAN transceiver circuit 134 performs an amplification processing, down conversion, and the like on the input reception signals, and outputs the processed reception signals to the controller. The controller performs a demodulation processing and the like on the reception signals input from the wireless LAN transceiver circuit 134 to reproduce control data, user data, and the like included in the reception signals.

<Structure of Each Antenna>

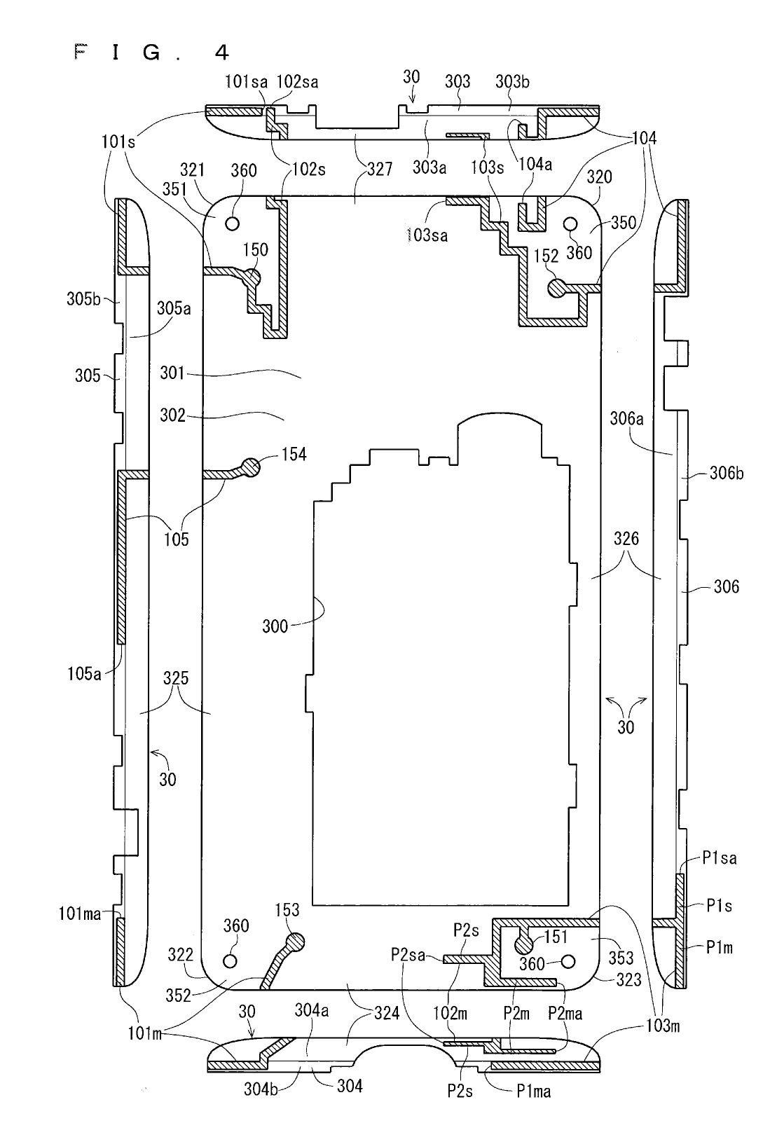

Various antennas included in the wireless processing executor 100 such as the first antenna group 101 are formed on, for example, the outer surface 301 of the battery-side case body 30. FIG. 4 illustrates structures of various antennas included in the wireless processing executor 100 and a structure of the battery-side case body 30.

The midsection of FIG. 4 illustrates a front view of the battery-side case body 30. The upper side, the lower side, the left side, and the right side of FIG. 4 illustrate a top view, a bottom view, a left side view, and a right side view of the battery-side case body 30, respectively. The midsection of FIG. 4 illustrates the battery-side case body 30 when seen from the side on which the cover member 31 is fitted.

The various antennas included in the wireless processing executor 100 such as the main antenna 101m are each formed of, for example, a conductive pattern. Similarly, the feeding points 150 to 154 are each formed of, for example, a conductive pattern. The various antennas and the feeding points 150 to 154 connected with the antennas are formed by printing, for example, a silver-based metallic material on the outer surface 301 of the battery-side case body 30. The feeding points 150 to 154 each have, for example, a round shape.

The battery-side case body 30 has a substantially shallow box shape. The outer surface 301 of the battery-side case body 30 having a substantially box shape includes a main surface 302 having a substantially rectangular shape in a plan view, a side surface 303 on the upper side (referred to as an “upper side surface 303”), a side surface 304 on the lower side (referred to as a “lower side surface 304”), a side surface 305 on the left side (referred to as a “left side surface 305”), and a side surface 306 on the right side (referred to as a “right side surface 306”). The above-mentioned opening 300 through which the battery 7 is inserted is formed in the main surface 302. The main surface 302 has four screw holes 360 formed in the four corners thereof.

The right side and the left side of the battery-side case body 30 in one embodiment refer to the right side and the left side of the battery-side case body 30 when seen from the side on which the cover member 31 is fitted while the upper side (the upper side based on the assumption that the user holding the electronic apparatus 1 in a hand sets the electronic apparatus 1 to the ear to have a telephone conversation) of the battery-side case body 30 faces upward as illustrated in the midsection of FIG. 4.

A boundary portion 327 between the main surface 302 and the upper side surface 303 is not angular but curved. That is, the portion extending from the edge portion of the main surface 302 on the upper side surface 303 side to the edge portion of the upper side surface 303 on the main surface 302 side is curved. Similarly, a boundary portion 324 between the main surface 302 and the lower side surface 304 is not angular but curved. A boundary portion 325 between the main surface 302 and the left side surface 305 is not angular but curved. A boundary portion 326 between the upper surface 302 and the right side surface 306 is not angular but curved.

An upper right corner 320, an upper left corner 321, a lower left corner 322, and a lower right corner 323 of the battery-side case body 30 are not angular but curved (rounded).

### <Shapes of GPS Antenna and Sub-antenna in 800 MHz Frequency Band>

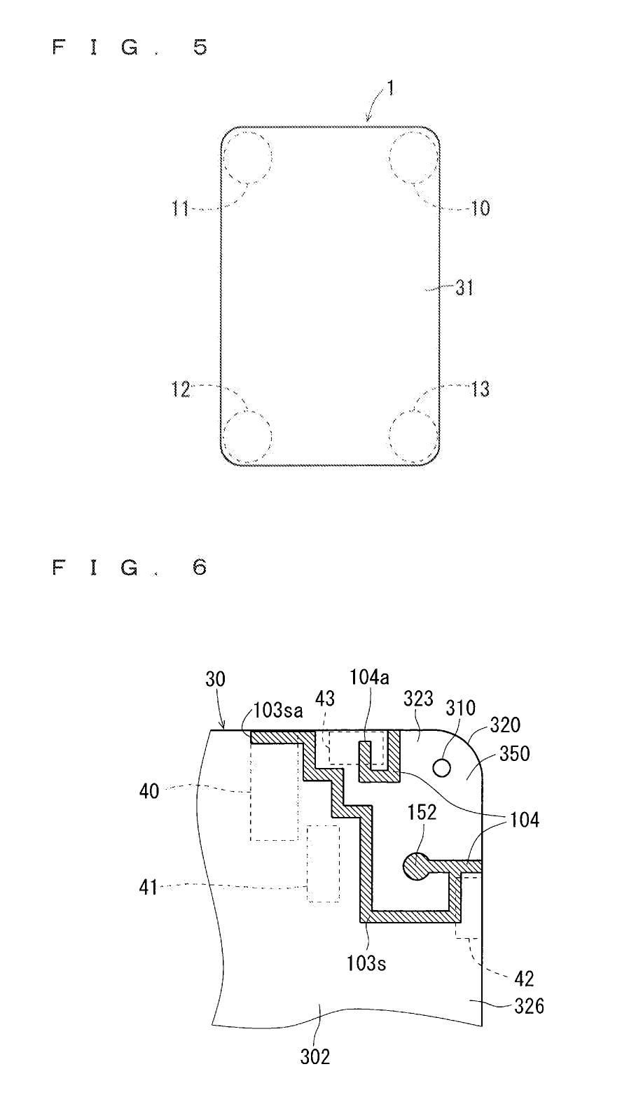

The GPS antenna 104 and the sub-antenna 103s in the 800 MHz frequency band that share the feeding point 152 are formed on an upper right corner portion 350 of the battery-side case body 30. In other words, the sub-antenna 103s and the GPS antenna 104 are formed in the vicinity of the upper right corner 320 of the battery-side case body 30. As illustrated in FIG. 5, with the battery-side case body 30 being installed in the electronic apparatus 1, the sub-antenna 103s and the GPS antenna 104 are formed on an upper right corner portion 10 of the inner side of the electronic apparatus 1 assuming that the electronic apparatus 1 is seen from the cover member 31 side (the back surface side). FIG. 5 also illustrates an upper left corner portion 11, a lower left corner portion 12, and a lower right corner portion 13 of the inner side of the electronic apparatus 1 assuming that the electronic apparatus 1 is seen from the cover member 31 side.

The frequency band (800 MHz frequency band) of wireless signals received by the sub-antenna 103s is lower than the frequency band (1.5 GHz frequency band) of GPS signals received by the GPS antenna 104, and thus the sub-antenna 103s is longer than the GPS antenna 104. The feeding point 152 is located on the main surface 302 side of the upper right corner portion 350 of the battery-side case body 30. In other words, the feeding point 152 is located in the vicinity of the upper right corner of the main surface 302 of the battery-side case body 30.

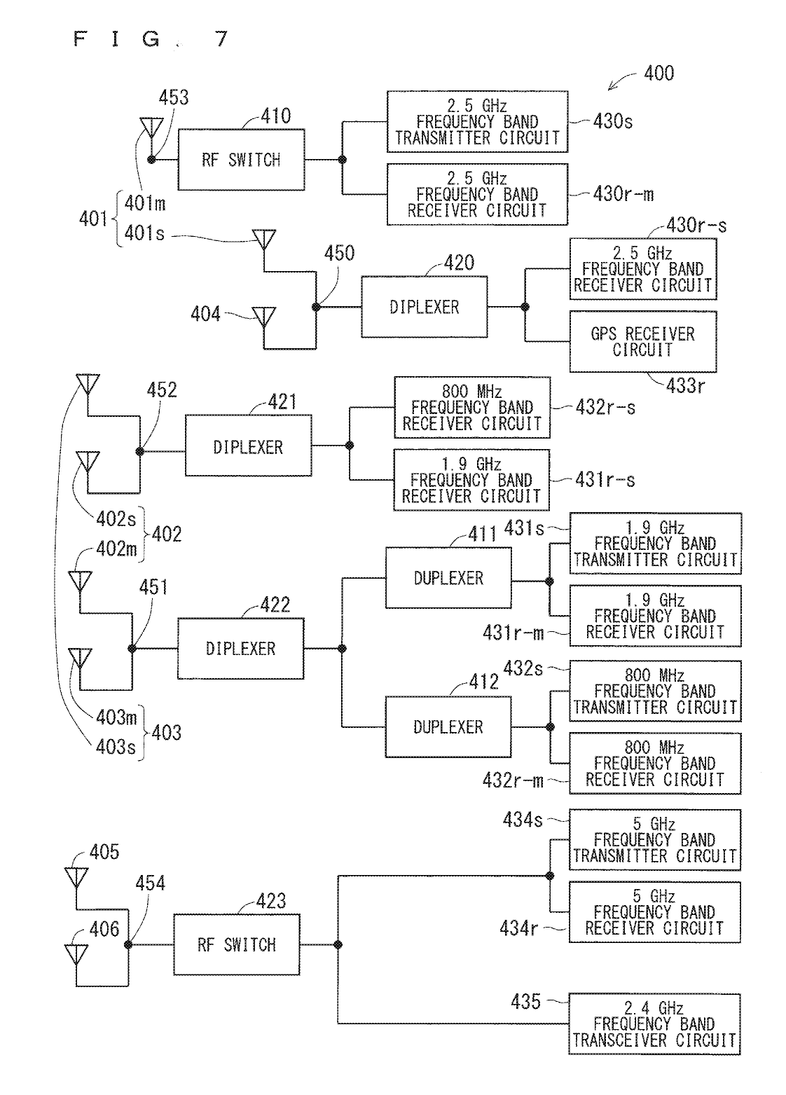

FIG. 6 illustrates an enlarged view of the area around the upper right corner portion 350 of the battery-side case body 30. As illustrated in FIG. 6, with the battery-side case body 30 being installed in the electronic apparatus 1, provided below the area around the upper right corner portion 350 of the battery-side case body 30 are components including an earphone jack 40, a vibrator 41, a side key 42, and a proximity sensor 43 accommodated in the apparatus case 4. The performance of the sub-antenna 103s and the GPS antenna 104 would be deteriorated if the components are located below the sub-antenna 103s and the GPS antenna 104, and thus the sub-antenna 103s and the GPS antenna 104 are disposed so as not to overlie the components as possible. Similarly, other antennas in the wireless processing executor 100 are disposed so as not to overlie the components in the apparatus case 4 as possible.

As illustrated in FIGS. 4 and 6, the GPS antenna 104 extends from the feeding point 152 toward the right side surface 306 so as not to overlie the side key 42 located nearby, and further extends through a curved portion 306a of the right side surface 306 (the edge portion of the right side surface 306 on the main surface 302 side) to a flat portion 306b of the right side surface 306. In other words, the GPS antenna 104 extends from the feeding point 152 toward the right side surface 306, and further extends through the curved boundary portion 326 between the main surface 302 and the right side surface 306 to the flat portion 306b of the right side surface 306. The GPS antenna 104 further extends from the flat portion 306b of the right side surface 306 through the curved upper right corner 320 of the battery-side case body 30 and to a flat portion 303b of the upper side surface 303. The GPS antenna 104 further extends from the flat portion 303b of the upper side surface 303 to the curved boundary portion 327 between the upper side surface 303 and the main surface 302, makes a 180-degree U turn leftward, and is terminated. An open end 104a of the GPS antenna 104 is located outboard with respect to the feeding point 152. In particular, the open end 104a of the GPS antenna 104 is located outboard with respect to the feeding point 152 on the periphery of the battery-side case body 30.

Meanwhile, the sub-antenna 103s in the 800 MHz frequency band extends from the feeding point 152 over a short distance toward the right side surface 306, and then makes a 180-degree U turn downward to extend toward the left side surface 305. The sub-antenna 103s extending toward the left side surface 305 extends slightly beyond the feeding point 152, and then makes a 90-degree turn toward the upper side surface 303 to extend toward the upper side surface 303. Then, the sub-antenna 103s extending toward the upper side surface 303 obliquely extends in a stepwise manner slightly toward the left side surface 305 so as not to overlie the vibrator 41, the earphone jack 40, and the proximity sensor 43 located nearby. The sub-antenna 103s is terminated at the point where the sub-antenna 103s reaches the curved boundary portion 327 between the main surface 302 and the upper side surface 303. Similarly to the open end 104a of the GPS antenna 104, an open end 103sa of the sub-antenna 103s is located outboard with respect to the feeding point 152. In particular, the open end 103sa of the sub-antenna 103s is located outboard with respect to the feeding point 152 on the periphery of the battery-side case body 30.

As described above, in the battery-side case body 30, the GPS antenna 104 is disposed nearer to the upper right corner 320 than the sub-antenna 103s in the 800 MHz frequency band is. With the battery-side case body 30 being installed in the electronic apparatus 1, the GPS antenna 104 is disposed nearer to the corner of the electronic apparatus 1 (nearer to the upper right corner of the electronic apparatus 1 assuming that the electronic apparatus 1 is seen from the cover member 31 side) than the sub-antenna 103s in the 800 MHz frequency band is. Thus, the components in the electronic apparatus 1 are less likely to be situated in the vicinity of the GPS antenna 104. This can regulate the deterioration of the performance of the GPS antenna 104 due to the influence of the components in the apparatus case 4. That is, the GPS antenna 104 can deliver improved performance.

The controller in the electronic apparatus 1 obtains the position of the electronic apparatus 1 on the basis of reception signals output from the GPS receiver circuit 133r. The controller would obtain the position with reduced accuracy if the GPS antenna 104 offers poor performance.

In a case where the electronic apparatus 1 makes an emergency call to the police or the like, the electronic apparatus 1 may notify the police or the like of the position of the electronic apparatus 1 such that the police or the like can pinpoint the position of the user. If the police or the like is notified of the incorrect position of the electronic apparatus 1, the police or the like would find it difficult to pinpoint the precise position of the user. In one embodiment, the improved performance of the GPS antenna 104 allows the controller to obtain the position of the electronic apparatus 1 with higher accuracy. Thus, in the case of an emergence call to the police or the like, the electronic apparatus 1 can notify the police or the like of the precise position of the electronic apparatus 1.

In a case where the open ends of the antennas, such as the GPS antenna, are not located outboard with respect to the battery-side case body 30 but located inboard with respect to the battery-side case body 30, the open ends are more likely to be coupled to the ground plane formed in, for example, the printed circuit board in the apparatus case 4. This may cause deterioration of the performance of the antennas. That is, in a case where the open ends of the antennas, such as the GPS antenna 104, are not located on the outer side but located on the inner side in the electronic apparatus 1, the open ends are more likely to be coupled to the ground plane in the electronic apparatus 1, and the performance of the antennas may be deteriorated accordingly.

In one embodiment, the open end 104a of the GPS antenna 104 and the open end 103sa of the sub-antenna 103s are located outboard with respect to the feeding point 152, more particularly, are located outboard with respect to the feeding point 152 on the periphery of the battery-side case body 30, and accordingly are less likely to be coupled to the ground plane in the apparatus case 4. This can improve the performance of the GPS antenna 104 and the sub-antenna 103s. With the battery-side case body 30 being installed in the electronic apparatus 1, the open end 104a of the GPS antenna 104 and the open end 103sa of the sub-antenna 103s are located on the periphery of the inner side of the electronic apparatus 1.

In one embodiment, the GPS antenna 104 is disposed in such a manner that the GPS antenna 104 does not lie inboard with respect to the feeding point 152 and that the open end 104a thereof is located outboard with respect to the feeding point 152. Thus, the GPS antenna 104 can be disposed nearer to the edge (nearer to the corner) in the electronic apparatus 1. Consequently, the GPS antenna 104 is less likely to be affected by the components in the apparatus case 4, and accordingly delivers improved performance.

Given that the open end 103sa of the sub-antenna 103s in the 800 MHz frequency band is disposed outboard with respect to the feeding point 152, it is not always required that the sub-antenna 103s lies inboard with respect to the feeding point 152 as in one embodiment such that the open end 103sa thereof is disposed outboard with respect to the feeding point 152. For example, the open end 103sa of the sub-antenna 103s can be disposed outboard with respect to the feeding point 152 in a case where the sub-antenna 103s extends from the feeding point 152 toward the right side surface 306 and then extends through the right side surface 306 in one direction toward the lower side surface 304.

If the sub-antenna 103s in the 800 MHz frequency band, which is longer than the GPS antenna 104, extends through the right side surface 306 in one direction toward the lower side surface 304, the open end 103sa of the sub-antenna 103s would reach the longitudinal midsection of the right side surface 306. With the electronic apparatus 1 being held by a hand of the user, the sub-antenna 103s is more likely to be covered by the hand of the user. This would cause deterioration of the performance of the sub-antenna 103s.

In one embodiment, the sub-antenna 103s is disposed in such a manner that the sub-antenna 103s lies inboard with respect to the feeding point 152 on the edge portion in the battery-side case body 30 and that the open end 103sa of the sub-antenna 103sa is located outboard with respect to the feeding point 152. As illustrated in FIG. 4, this eliminates the need for stretching the long sub-antenna 103s lengthwise in one direction and allows the open end 103sa to sit on the outer side. Consequently, the sub-antenna 103s is less likely to be covered by the hand of the user. This improves the performance of the sub-antenna 103s.

### <Shapes of Sub-Antenna in 2.5 GHz Frequency Band and Sub-Antenna in 1.9 GHz Frequency Band>

The sub-antenna 101s in the 2.5 GHz frequency band and the sub-antenna 102s in the 1.9 GHz frequency band that share the feeding point 150 are formed on an upper left corner portion 351 of the battery-side case body 30. With the battery-side case body 30 being installed in the electronic apparatus 1, the sub-antennas 101s and 102s are formed on the upper left corner portion 11 of the inner side of the electronic apparatus 1 assuming that the electronic apparatus 1 is seen from the cover member 31 side (see FIG. 5). The feeding point 150 is located on the main surface 302 side of the upper left corner portion 351 of the battery-side case body 30. In other words, the feeding point 150 is located in the vicinity of the upper left corner of the main surface 302 of the battery-side case body 30.

In one embodiment, the requisite performance for the sub-antenna 101s in the 2.5 GHz frequency band is higher than the requisite performance for the sub-antenna 102s in the 1.9 GHz frequency band. In particular, the signal loss acceptable for the sub-antenna 101s in the 2.5 GHz frequency band is smaller than the signal loss acceptable for the sub-antenna 102s in the 1.9 GHz frequency band.

The frequency band (1.9 GHz frequency band) of wireless signals received by the sub-antenna 102s is lower than the frequency band (2.5 GHz frequency band) of wireless signals received by the sub-antenna 101s. Thus, the sub-antenna 102s is longer than the sub-antenna 101s.

The sub-antenna 101s in the 2.5 GHz frequency band extends from the feeding point 150 toward the left side surface 305, and further extends across a curved portion 305a of the left side surface 305 to a flat portion 305b of the left side surface 305. The sub-antenna 101s further extends from the flat portion 305b of the left side surface 305 through the curved upper left corner 321 of the battery-side case body 30 and to the flat portion 303b of the upper side surface 303, and is terminated. An open end 101sa of the sub-antenna 101s is located outboard with respect to the feeding point 150. In particular, the open end 101sa of the sub-antenna 101s is located outboard with respect to the feeding point 150 on the periphery of the battery-side case body 30 (the periphery of the inner side of the electronic apparatus 1).

Meanwhile, the sub-antenna 102s in the 1.9 GHz frequency band obliquely extends in a stepwise manner from the feeding point 150 toward the lower side surface 304 while approaching the right side surface 306, and then makes a 180-degree U turn rightward to extend toward the upper side surface 303. The sub-antenna 102s makes a turn to extend over a short distance through the boundary portion 327 between the main surface 302 and the upper side surface 303 toward the left side surface 305, further extends across a curved portion 303a of the upper side surface 303 to the flat portion 303b of the upper side surface 303, and is terminated. An open end 102sa of the sub-antenna 102s is located outboard with respect to the feeding point 150 on the periphery of the battery-side case body 30.

As described above, in the battery-side case body 30 in one embodiment, the sub-antenna 101s in the 2.5 GHz frequency band is disposed nearer to the upper left corner 321 than the sub-antenna 102s in the 1.9 GHz frequency band is, the sub-antenna 101s being required to achieve relatively high requisite performance, the sub-antenna 102s being required to achieve relatively low requisite performance. With the battery-side case body 30 being installed in the electronic apparatus 1, the sub-antenna 101s is disposed nearer to the corner of the electronic apparatus 1 (nearer to the upper left corner of the electronic apparatus 1 assuming that the electronic apparatus 1 is seen from the cover member 31 side) than the sub-antenna 102s is. Thus, the components in the electronic apparatus 1 are less likely to be situated in the vicinity of the sub-antenna 101s. This can regulate the deterioration of the performance of the sub-antenna 101s due to the influence of the components in the apparatus case 4. Consequently, the high performance required of the sub-antenna 101s can be achieved more easily.

The open end 101sa of the sub-antenna 101s and the open end 102sa of the sub-antenna 102s are located outboard with respect to the feeding point 150, more particularly, are located outboard with respect to the feeding point 150 on the periphery of the battery-side case body 30, and accordingly are less likely to be coupled to the ground plane in the apparatus case 4. This can improve the performance of the sub-antennas 101s and 102s. With the battery-side case body 30 being installed in the electronic apparatus 1, the open end 101sa of the sub-antenna 101s and the open end 102sa of the sub-antenna 102s are located on the periphery of the inner side of the electronic apparatus 1.

The sub-antenna 101s is disposed in such a manner that the sub-antenna 101s does not lie inboard with respect to the feeding point 150 and that the open end 101sa thereof is located outboard with respect to the feeding point 150. Thus, the sub-antenna 101s can be disposed nearer to the edge (nearer to the corner) in the electronic apparatus 1. Consequently, the sub-antenna 101s is less likely to be affected by the components in the apparatus case 4, and accordingly delivers improved performance.

In a case where the shorter sub-antenna 101s in the 2.5 GHz frequency band is disposed in such a manner that the sub-antenna 101s lies inboard with respect to the feeding point 150, the open end 101sa of the sub-antenna 101s can hardly sit nearer to the edge. Consequently, the open end 101sa is more likely to be coupled to the ground plane in the apparatus case 4. In this respect, it is not preferable that the shorter sub-antenna 101s in the 2.5 GHz frequency band be disposed so as to lie inboard with respect to the feeding point 150.

### <Shape of Wireless LAN Antenna>

The feeding point 154 for the wireless LAN antenna 105 is formed on the longitudinal midsection of the left edge portion of the main surface 302 somewhat close to the upper side surface 303.

The wireless LAN antenna 105 extends from the feeding point 154 toward the left side surface 305, and further extends across the curved portion 305a of the left side surface 305 to the flat portion 305b of the left side surface 305. The wireless LAN antenna 105 further extends through the flat portion 305b of the left side surface 305 toward the lower side surface 304. The wireless LAN antenna 105 thereof further extends in such a manner that the open end 105a reaches the longitudinal midsection of the flat portion 305b of the left side surface 305 somewhat close to the lower side surface 304, and is terminated at this point. An open end 105a of the wireless LAN antenna 105 is located outboard with respect to the feeding point 154.

As described above, the open end 105a of the wireless LAN antenna 105 is located outboard with respect to the feeding point 154, more particularly, is located outboard with respect to the feeding point 154 on the periphery of the battery-side case body 30. Thus, the open end 105a is less likely to be coupled to the ground plane in the apparatus case 4. This improves the performance of the wireless LAN antenna 105.

The wireless LAN antenna 105 is disposed in such a manner that the wireless LAN antenna 105 does not lie inboard with respect to the feeding point 154 and that the open end 105a thereof is located outboard with respect to the feeding point 154. Thus, the wireless LAN antenna 105 can be disposed nearer to the edge as possible. Consequently, the wireless LAN antenna 105 is less likely to be affected by the components in the apparatus case 4, and accordingly delivers improved performance.

### <Shape of Main Antenna in 2.5 GHz Frequency Band>

The main antenna 101m in the 2.5 GHz frequency band is formed on a lower left corner portion 352 of the battery-side case body 30. With the battery-side case body 30 being installed in the electronic apparatus 1, the main antenna 101m is formed on the lower left corner portion 12 of the inner side of the electronic apparatus 1 assuming that the electronic apparatus 1 is seen from the cover member 31 side (see FIG. 5). The feeding point 153 of the main antenna 101m is located on the main surface 302 side of the lower left corner portion 352 of the battery-side case body 30.

The main antenna 101m obliquely extends from the feeding point 153 toward the lower side surface 304 while extending somewhat close to the left side surface 305, and further extends across a curved portion 304a of the lower side surface 304 to a flat portion 304b of the lower side surface 304. The main antenna 101m extends from the flat portion 304b of the lower side surface 304 through the curved lower left corner 322 of the battery-side case body 30 and to the flat portion 305b of the left side surface 305, and is terminated. An open end 101ma of the main antenna 101m is located outboard with respect to the feeding point 153 on the periphery of the battery-side case body 30.

As described above, the open end 101ma of the main antenna 101m is located outboard with respect to the feeding point 153, and accordingly is less likely to be coupled to the ground plane in the apparatus case 4. This improves the performance of the main antenna 101m.

The main antenna 101m is disposed in such a manner that the main antenna 101m does not lie inboard with respect to the feeding point 153 and that the open end 101ma thereof is located outboard with respect to the feeding point 153. Thus, the main antenna 101m can be disposed nearer to the edge (closer to the corner) in the electronic apparatus 1. Consequently, the main antenna 101m is less likely to be affected by the components in the apparatus case 4, and accordingly delivers improved performance.

### <Shapes of Main Antenna in 1.9 GHz Frequency Band and Main Antenna in 800 MHz Frequency Band>

The main antenna 102m in the 1.9 GHz frequency band and the main antenna 103m in the 800 MHz frequency band that share the feeding point 151 are formed on a lower right corner portion 353 of the battery-side case body 30. With the battery-side case body 30 being installed in the electronic apparatus 1, the main antennas 102m and 103m are formed on the lower right corner portion 13 of the inner surface of the electronic apparatus 1 assuming that the electronic apparatus 1 is seen from the cover member 31 side (see FIG. 5).

The frequency band (800 MHz frequency band) of wireless signals received by main antenna 103m is lower than the frequency band (1.9 GHz frequency band) of wireless signals received by the main antenna 102m. Thus, the main antenna 103m is longer than the main antenna 102m. The feeding point 151 is located on the main surface 302 side of the lower right corner portion 353 of the battery-side case body 30.

The main antenna 103m in the 800 MHz frequency band extends from the feeding point 151 over a short distance toward the upper side surface 303. Then, the main antenna 103m extends toward the right side surface 306, and further extends across the curved portion 306a of the right side surface 306 to the flat portion 306b of the right side surface 306. The main antenna 103m reaches the flat portion 306b of the right side surface 306 to branch off into a sub-pattern P1s and a main pattern P1m. The sub-pattern P1s extends through the flat portion 306b of the right side surface 306 toward the upper side surface 303, and is terminated. The main pattern P1m extends through the flat portion 306b of the right side surface 306 toward the lower side surface 304, further extends from the flat portion 306b of the right side surface 306 through the curved lower right corner 323 of the battery-side case body 30 and to the flat portion 304b of the lower side surface 304, and is terminated. An open end P1sa of the sub-pattern P1s and an open end P1ma of the main pattern P1m are located outboard with respect to the feeding point 151.

Meanwhile, the main antenna 102m in the 1.9 GHz frequency band extends from the feeding point 151 over a short distance toward the upper side surface 303, and then makes a 180-degree U turn leftward to extend toward the lower side surface 304. Then, the main antenna 102m reaches the curved boundary portion 324 between the main surface 302 and the lower side surface 304 to branch off into a sub-pattern P2s and a main pattern P2m. The sub-pattern P2s extends through the boundary portion 324 over a short distance toward the left side surface 305, and is terminated. The main pattern P2m extends through the boundary portion 324 over a short distance toward the lower side surface 304. Then, the main pattern P2m makes a 90-degree turn rightward to extend toward the right side surface 306, and is terminated. An open end P2sa of the sub-pattern P2s and an open end P2ma of the main pattern P2m are located outboard with respect to the feeding point 151.

As described above, the open ends (the open ends P2sa and P2ma) of the main antenna 102m are located outboard with respect to the feeding point 151, and accordingly are less likely to be coupled to the ground plane in the apparatus case 4. This improves the performance of the main antenna 102m.

The open ends (the open ends P1sa and P1ma) of the main antenna 103m are located outboard with respect to the feeding point 151, and accordingly are less likely to be coupled to the ground plane in the apparatus case 4. This improves the performance of the main antenna 103m.

### Embodiment 2

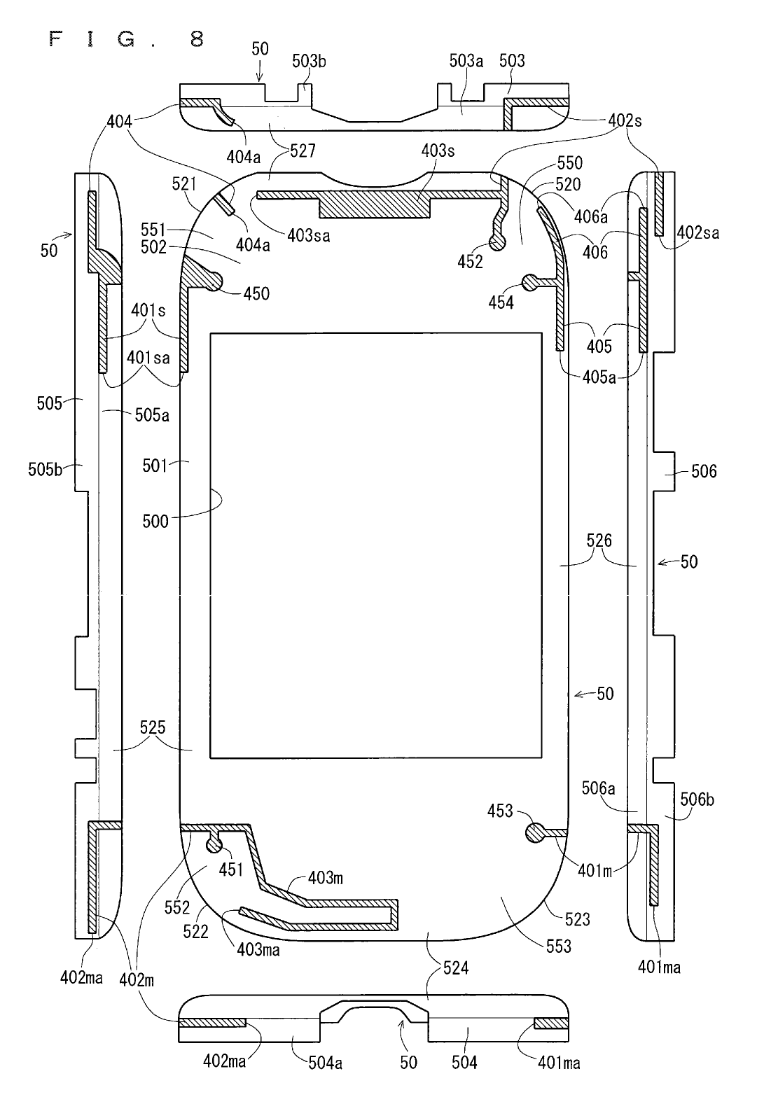

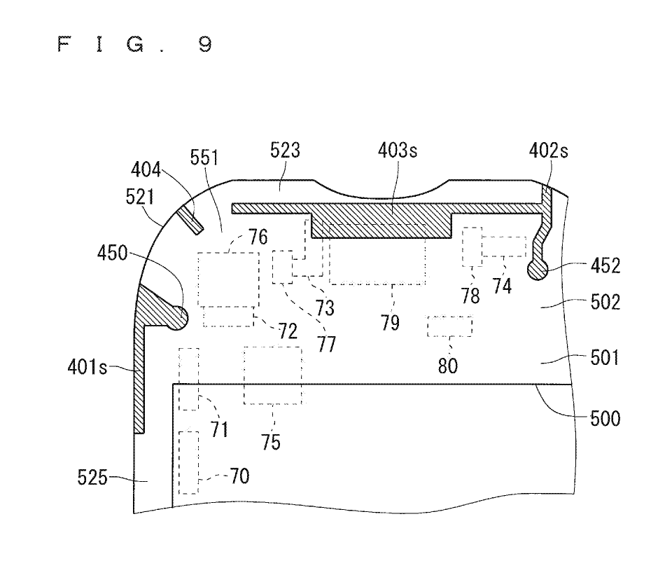

FIG. 7 illustrates a configuration of a wireless processing executor 400 included in the electronic apparatus 1 according to an embodiment 2. FIG. 8 illustrates structures of various antennas included in the wireless processing executor 400 and a structure of a battery-side case body 50 included in the electronic apparatus 1 according to the embodiment 2. The electronic apparatus 1 is obtained by replacing the wireless processing executor 100 of the electronic apparatus 1 in the above-mentioned embodiment 1 with the wireless processing executor 400 and replacing the battery-side case body 30 of the electronic apparatus 1 in the above-mentioned embodiment 1 with the battery-side case body 50. The following describes the electronic apparatus 1 according to one embodiment with particular emphasis on the difference between the electronic apparatus 1 according to one embodiment and the electronic apparatus 1 according to the embodiment 1.

### <Configuration of Wireless Processing Executor>

Similarly to the wireless processing executor 100 according to the embodiment 1, the wireless processing executor 400 can perform wireless communication with a base station through the use of wireless signals in the 2.5 GHz frequency band, 1.9 GHz frequency band, and the 800 MHz frequency band. In one embodiment, the wireless processing executor 400 can transmit and receive wireless signals in the 2.5 GHz frequency band, the 1.9 GHz frequency band, and the 800 MHz frequency band in LTE as well as wireless signals in the 1.9 GHz frequency band and the 800 MHz frequency band in CDMA. The wireless processing executor 400 can receive wireless signals from a satellite in the satellite positioning system, such as GPS. The wireless processing executor 400 can perform wireless communication with a communication apparatus through a wireless LAN, such as WiFi. In one embodiment, the wireless processing executor 400 can perform wireless communication with a communication apparatus through WiFi in which wireless signals in the 2.4 GHz frequency band are used and through WiFi in which the wireless signals in the 5 GHz frequency band are used.

As illustrated in FIG. 7, the wireless processing executor 400 includes a first antenna group 401 that can transmit and receive wireless signals in the 2.5 GHz frequency band, a second antenna group 402 that can transmit and receive wireless signals in the 1.9 GHz frequency band, and a third antenna group 403 that can transmit and receive wireless signals in the 800 MHz frequency band. Wireless signals that can be transmitted and received by the first antenna group 401 are equivalent to wireless signals that can be transmitted and received by the first antenna group 101 mentioned above. Wireless signals that can be transmitted and received by the second antenna group 402 are equivalent to wireless signals that can be transmitted and received by the second antenna group 102 mentioned above. Wireless signals that can be transmitted and received by the third antenna group 403 are equivalent to wireless signals that can be transmitted and received by the third antenna group 103.

The wireless processing executor 400 includes a GPS antenna 404 that can receive GPS signals, a wireless LAN antenna 405 that can transmit and receive wireless signals in the 5 GHz frequency band in a wireless LAN, and a wireless LAN antenna 406 that can transmit and receive wireless signals in the 2.4 GHz frequency band in the wireless LAN.

The first antenna group 401 in the 2.5 GHz frequency band includes a main antenna 401m that can perform transmission and reception and a sub-antenna 401s that can perform only reception. The first antenna group 401 performs transmission only through the main antenna 401m and performs reception through the main antenna 401m and the sub-antenna 401s. That is, the first antenna group 401 functions as a multi-antenna only during reception.

The second antenna group 402 in the 1.9 GHz frequency band includes a main antenna 402m that can perform transmission and reception and a sub-antenna 402s that can perform only reception. The second antenna group 402 performs transmission only through the main antenna 402m and performs reception through the main antenna 402m and the sub-antenna 402s. That is, the second antenna group 402 functions as a multi-antenna only during reception.

The third antenna group 403 in the 800 MHz frequency band includes a main antenna 403m that can perform transmission and reception and a sub-antenna 403s that can perform only reception. The third antenna group 403 performs transmission only through the main antenna 403m and performs reception through the main antenna 403m and the sub-antenna 403s. That is, the third antenna group 403 functions as a multi-antenna only during reception.

Each of the first antenna group 401, the second antenna group 402, and the third antenna group 403 is used as a MIMO receiving multi-antenna that receives MIMO signals from a base station during reception. At least one of the first antenna group 401, the second antenna group 402, and the third antenna group 403 may be used as a multi-antenna other than the MIMO multi-antenna. For example, at least one of the first antenna group 401, the second antenna group 402, and the third antenna group 403 may be used as an adaptive array multi-antenna that controls at least one of the antenna-directional bean and null. Furthermore, at least one of the first antenna group 401, the second antenna group 402, and the third antenna group 403 may be used as a diversity multi-antenna.

The GPS antenna 404 and the sub-antenna 401s in the 2.5 GHz frequency band share a feeding point 450. The main antenna 402m in the 1.9 GHz frequency band and the main antenna 403m in the 800 MHz frequency band share a feeding point 451. The sub-antenna 403s in the 800 MHz frequency band and the sub-antenna 402s in the 1.9 GHz frequency band share a feeding point 452. The wireless LAN antenna 405 in the 5 GHz frequency band and the wireless LAN antenna 406 in the 2.4 GHz frequency band share a feeding point 454. A feeding point 453 for the main antenna 401m in the 2.5 GHz frequency band is not shared with another antenna.

The wireless processing executor 400 includes a 2.5 GHz frequency band transmitter circuit 430s, a 1.9 GHz frequency band transmitter circuit 431s, an 800 MHz frequency band transmitter circuit 432s, a 5 GHz frequency band transmitter circuit 434s for the wireless LAN, and a 2.4 GHz frequency band transceiver circuit 435 for the wireless LAN.

The wireless processing executor 400 includes two 2.5 GHz frequency band receiver circuits, namely 2.5 GHz frequency band receiver circuits 430r-m and 430r-s, two 1.9 GHz frequency band receiver circuits, namely 1.9 GHz frequency band receiver circuits 431r-m and 431r-s, two 800 MHz frequency band receiver circuits, namely 800 MHz frequency band receiver circuits 432r-m and 432r-s, a GPS receiver circuit 433r, and a 5 GHz frequency band receiver circuit 434r for the wireless LAN.

The wireless processing executor 400 further includes two RF switches, namely RF switches 410 and 423, two duplexers, namely duplexers 411 and 412, and three diplexers, namely diplexers 420, 421, and 422. The RF switch 410 is connected with the feeding point 453 for the main antenna 401m in the 2.5 GHz frequency band. The diplexer 420 is connected with the feeding point 450 for the GPS antenna 404 and the sub-antenna 401s in the 2.5 GHz frequency band. The diplexer 421 is connected with the feeding point 452 for the sub-antenna 402s in the 1.9 GHz frequency band and the sub-antenna 403s in the 800 MHz frequency band. The diplexer 422 is connected with the feeding point 451 for the main antenna 402m in the 1.9 GHz frequency band and the main antenna 403m in the 800 MHz frequency band. The RF switch 423 is connected with the feeding point 454 for the wireless LAN antennas 405 and 406.

### <Transmission Processing>

The 2.5 GHz frequency band transmitter circuit 430s, the 1.9 GHz frequency band transmitter circuit 431s, and the 800 MHz frequency band transmitter circuit 432s operate in the same manner as the 2.5 GHz frequency band transmitter circuit 130s, the 1.9 GHz frequency band transmitter circuit 131s, and the 800 MHz frequency band transmitter circuit 132s mentioned above.

Transmission signals in the 2.5 GHz frequency band generated by the 2.5 GHz frequency band transmitter circuit 430s are input to the main antenna 401m through the RF switch 410. Transmission signals in the 1.9 GHz frequency band generated by the 1.9 GHz frequency band transmitter circuit 431s are input to the main antenna 402m through the duplexer 411 and the diplexer 422. Transmission signals in the 800 MHz frequency band generated by the 800 MHz frequency band transmitter circuit 432s are input to the main antenna 403m through the duplexer 412 and the diplexer 422.

The 5 GHz frequency band transmitter circuit 434s performs up conversion, an amplification processing, and the like on transmission signals input from the controller in the electronic apparatus 1 to generate transmission signals in the 5 GHz frequency band for the wireless LAN. The transmission signals in the 5 GHz frequency band are input to the wireless LAN antenna 405 through the RF switch 423.

The 2.4 GHz frequency band transceiver circuit 435 performs up conversion, an amplification processing, and the like on transmission signals input from the controller in the electronic apparatus 1 to generate transmission signals in the 2.4 GHz frequency band for the wireless LAN. The transmission signals in the 2.4 GHz frequency band are input to the wireless LAN antenna 406 through the RF switch 423.

### <Reception Processing>

Reception signals received by the main antenna 401m in the 2.5 GHz frequency band are input to the 2.5 GHz frequency band receiver circuit 430r-m through the RF switch 410. Reception signals received by the sub-antenna 401s in the 2.5 GHz frequency band are input to the 2.5 GHz frequency band receiver circuit 430r-s through the diplexer 420. The 2.5 GHz frequency band receiver circuits 430r-m and 430r-s operate in the same manner as the 2.5 GHz frequency band receiver circuits 130r-m and the 130r-sm mentioned above. The controller performs a demodulation processing and the like on the reception signals output from the 2.5 GHz frequency band receiver circuits 430r-m and 430r-s to reproduce control data, user data, and the like included in wireless signals in the 2.5 GHz frequency band transmitted by the base station.

Reception signals received by the sub-antenna 402s in the 1.9 GHz frequency band are input to the 1.9 GHz frequency band receiver circuit 431r-s through the diplexer 421. Reception signals received by the main antenna 402m in the 1.9 GHz frequency band are in put to the 1.9 GHz frequency band receiver circuit 431r-m through the diplexer 422 and the duplexer 411. The 1.9 GHz frequency band receiver circuits 431r-m and 431r-s operate in the same manner as the 1.9 GHz frequency band receiver circuits 131r-m and 131r-s mentioned above. The controller performs a demodulation processing and the like on the reception signals output from the 1.9 GHz frequency band receiver circuits 431r-m and 431r-s to reproduce control data, user data, and the like included in wireless signals in the 1.9 GHz frequency band transmitted from the base station.

Reception signals received by the main antenna 403m in the 800 MHz frequency band are input to the 8 MHz frequency band receiver circuit 432r-m through the diplexer 422 and the duplexer 412. Reception signals received by the sub-antenna 403s in the 800 MHz frequency band are input to the 800 MHz frequency band receiver circuit 432r-s through the diplexer 421. The 800 MHz frequency band receiver circuits 432r-m and 432r-s operate in the same manner as the 800 MHz frequency band receiver circuits 132r-m and 132r-s mentioned above. The controller performs a demodulation processing and the like on the reception signals output from the 800 MHz frequency band receiver circuits 432r-m and 432r-s to reproduce control data, user data, and the like included in wireless signals in the 800 MHz frequency band transmitted from the base station.

Reception signals received by the GPS antenna 404 are input to the GPS receiver circuit 433r through the diplexer 420. The GPS receiver circuit 433r operates in the same manner as the GPS receiver circuit 133r mentioned above. The controller performs a demodulation processing and the like on the reception signals input from the GPS receiver circuit 433r to reproduce control data, user data, and the like included in the reception signals.

Reception signals received by the wireless LAN antenna 405 are input to the 5 GHz frequency band receiver circuit 434r through the RF switch 423. The 5 GHz frequency band receiver circuit 434r performs an amplification processing, down conversion, and the like on the input reception signals, and outputs the processed reception signals to the controller. The controller performs a demodulation processing and the like on the reception signals input from the 5 GHz frequency band receiver circuit 434r to reproduce control data, user data, and the like included in the reception signals.

Reception signals received by the wireless LAN antenna 406 are input to the 2.4 GHz frequency band transceiver circuit 435 through the FR switch 324. The 2.4 GHz frequency band transceiver circuit 435 performs an amplification processing, down conversion, and the like on the input reception signals, and outputs the processed reception signals to the controller. The controller performs a demodulation processing and the like on the reception signals input from the 2.4 GHz frequency band transceiver circuit 435 to reproduce control data, user data, and the like included in the reception signals.

### <Structure of Each Antenna>

Various antennas included in the wireless processing executor 400 such as the first antenna group 401 are formed on, for example, an outer surface 501 of the battery-side case body 50 as illustrated in FIG. 8. The midsection of FIG. 8 illustrates a front view of the battery-side case body 50. The upper side, the lower side, the left side, and the right side of FIG. 8 illustrate a top view, a bottom view, a left side view, and a right side view of the battery-side case body 50, respectively. The midsection of FIG. 5 illustrates the battery-side case body 50 when seen from the side on which the cover member 31 is fitted.

The various antennas included in the wireless processing executor 400 such as the main antenna 401m are each formed of, for example, a conductive pattern. Similarly, the feeding points 450 to 454 connected with the antennas are each formed of, for example, a conductive pattern. The various antennas and the feeding points 450 to 454 are formed by printing, for example, a silver-based metallic material on the outer surface 501 of the battery-side case body 50. The feeding points 450 to 454 each have, for example, a round shape.

The battery-side case body 50 has a substantially shallow box shape. The outer surface 501 of the battery-side case body 50 includes a main surface 502 having a substantially rectangular shape in a plan view, a side surface 503 on the upper side (referred to as an “upper side surface 503”), a side surface 504 on the lower side (referred to as a “lower side surface 504), a side surface 505 on the left side (referred to as a “left side surface 505”), and a side surface 506 on the right side (referred to as a “right side surface 506”). The main surface 502 has an opening 500 through which the battery 7 is inserted.

A boundary portion 527 between the main surface 502 and the upper side surface 503 is not angular but curved. That is, the portion extending from the edge portion of the main surface 502 on the upper side surface 503 side to the edge portion of the upper side surface 503 on the main surface 502 side is curved. Similarly, a boundary portion 524 between the main surface 502 and the lower side surface 504 is not angular but curved. A boundary portion 525 between the main surface 502 and the left side surface 505 is not angular but curved. A boundary portion 526 between the main surface 502 and the right side surface 506 is not angular but curved.

An upper right corner 520, an upper left corner 521, a lower left corner 522, and a lower right corner 523 of the battery-side case body 50 are not angular but curved.

### <Shapes of GPS Antenna and Sub-antenna in 2.5 GHz Frequency Band>

The GPS antenna 404 and the sub-antenna 401s in the 2.5 GHz frequency band that share the feeding point 450 are formed on an upper left corner portion 551 of the battery-side case body 50. The frequency band (2.5 GHz frequency band) of wireless signals received by the sub-antenna 401s is higher than the frequency band (1.5 GHz frequency band) of GPS signals received by the GPS antenna 404. Thus, the sub-antenna 401s is shorter than the GPS antenna 404. The feeding point 450 is located on the main surface 502 side of the upper left corner portion 551 of the battery-side case body 50.

FIG. 9 illustrates an enlarged view of the area extending from the upper left corner 521 to around the upper edge of the battery-side case body 50. As illustrated in FIG. 9, with the battery-side case body 50 being installed in the electronic apparatus 1, provided below the area extending from the upper left corner 521 to around the upper edge of the battery-side case body 50 are components including flexible cables 70 to 74, cameras 75 and 76, connectors 77 and 78, an earphone jack 79, and a vibrator 80 accommodated in the apparatus case 4. The performance of the sub-antenna 401s and the GPS antenna 404 would be deteriorated if the components are located below the sub-antenna 401s and the GPS antenna 404. Thus, the sub-antenna 401s and the GPS antenna 404 are disposed so as not to overlie the components as possible. Similarly, other antennas in the wireless processing executor 400 are disposed so as not to overlie the components in the apparatus case 4 as possible.

As illustrated in FIG. 8, the GPS antenna 404 extends from the feeding point 450 toward the left side surface 505, and further extends across a curved portion 505a of the left side surface 505 to a flat portion 505b of the left side surface 505. The GPS antenna 404 further extends from the flat portion 505b of the left side surface 505 to the curved upper left corner 521 of the battery-side case body 50, and then makes a turn at around the inflection point of the upper left corner 521 to extend toward the main surface 502. The GPS antenna 404 is terminated at the point where an open end 404a thereof reaches around the upper left corner of the main surface 502.

Meanwhile, the sub-antenna 401s in the 2.5 GHz frequency band extends from the feeding point 450 toward the left side surface 505, extends to the curved boundary portion 525 between the left side surface 505 and the main surface 502, further extends to some extent through the boundary portion 525 toward the lower side surface 504, and then is terminated. An open end 401sa of the sub-antenna 401s is located outboard with respect to the feeding point 450.

As described above, in the battery-side case body 50, the GPS antenna 404 is disposed nearer to the upper left corner 521 than the sub-antenna 401s in the 2.5 GHz frequency band is. With the battery-side case body 50 being installed in the electronic apparatus 1, the GPS antenna 404 is disposed nearer to the corner of the electronic apparatus 1 (nearer to the upper left corner of the electronic apparatus 1 assuming that the electronic apparatus 1 is seen from the cover member 31 side) than the sub-antenna 401s in the 2.5 GHz frequency band is. Thus, the components in the electronic apparatus 1 are less likely to be situated in the vicinity of the GPS antenna 404. This can regulate the deterioration of the performance of the GPS antenna 404 due to the influence of the components in the apparatus case 4. Similarly to the GPS antenna 104 according to the embodiment 1, the GPS antenna 404 can accordingly deliver improved performance.

The open end 401sa of the sub-antenna 401s in the 2.5 GHz frequency band is located outboard with respect to the feeding point 450, and accordingly is less likely to be coupled to the ground plane in the apparatus case 4. This can improve the performance of the sub-antenna 401s.

The sub-antenna 401s is disposed in such a manner that the sub-antenna 401s does not lie inboard with respect to the feeding point 450 and that the open end 401sa thereof is located outboard with respect to the feeding point 450. Thus, the sub-antenna 401s can be disposed nearer to the edge in the electronic apparatus 1. Consequently, the sub-antenna 401s is less likely to be affected by the components in the apparatus case 4, and accordingly delivers improved performance.

In a case where the shorter sub-antenna 401s in the 2.5 GHz frequency band is disposed in such a manner that the sub-antenna 401s lies inboard with respect to the feeding point 450, the open end 401sa of the sub-antenna 401s can hardly sit nearer to the edge. Consequently, the open end 401sa is more likely to be coupled to the ground plane in the apparatus case 4. Thus, it is not preferable that the shorter sub-antenna 401s in the 2.5 GHz frequency band be disposed so as to lie inboard with respect to the feeding point 450.

### <Shapes of Main Antenna in 1.9 GHz Frequency Band and Main Antenna in 800 MHz Frequency Band>

The main antenna 402m in the 1.9 GHz frequency band and the main antenna 403m in the 800 MHz frequency band that share the feeding point 451 are formed on the lower edge portion of the battery-side case body 30. The feeding point 451 is located on the main surface 502 side of a lower left corner portion 552 of the battery-side case body 50.

The main antenna 402m in the 1.9 GHz frequency band extends from the feeding point 451 over a short distance toward the upper side surface 503. Then, the main antenna 402m extends toward the left side surface 505, and further extends across the curved portion 505a of the left side surface 505 to the flat portion 505b of the left side surface 505. The main antenna 402m further extends from the flat portion 505b of the left side surface 505 to the curved lower left corner 522 of the battery-side case body 50, and is terminated at the point where an open end 402ma of the main antenna 402m extends close to a flat portion 504a of the lower side surface 504. The main antenna 402m is formed on the lower left corner portion 552 of the battery-side case body 50. The open end 402ma of the main antenna 402m is located outboard with respect to the feeding point 451.

Meanwhile, the main antenna 403m in the 800 MHz frequency band extends from the feeding point 451 over a short distance toward the upper side surface 503, and then extends over a short distance toward the right side surface 506. Then, the main antenna 403m extends through the main surface 502 along the curved lower left corner 522 of the battery-side case body 50. The main antenna 403m further extends to around the horizontal midsection of the lower edge portion of the main surface 502 of the battery-side case body 50, and then makes a 180-degree U turn downward to extend through the main surface 502 toward the left side surface 505. The main antenna 402m is terminated at the point where an open end 403ma thereof reaches the lower left corner of the main surface 502. The open end 403ma of the main antenna 403m is located slightly outboard with respect to the feeding point 451.

As described above, the open ends 402ma and 403ma of the main antennas 402m and 403m are located outboard with respect to the feeding point 451, and accordingly are less likely to be coupled to the ground plane in the apparatus case 4. This improves the performance of the main antennas 402m and 403m.

The main antenna 402m in the 1.9 GHz frequency band is disposed in such a manner that the main antenna 402m does not lie inboard with respect to the feeding point 451 and that the open end 402ma thereof is located outboard with respect to the feeding point 451. Thus, the main antenna 402m can be disposed nearer to the edge (nearer to the corner) in the electronic apparatus 1. Consequently, the main antenna 402m is less likely to be affected by the components in the apparatus case 4, and accordingly delivers improved performance.

### <Shape of Main Antenna in 2.5 GHz Frequency Band>

The main antenna 401m in the 2.5 GHz frequency band is formed on a lower right corner portion 553 of the battery-side case body 50. The feeding point 453 of the main antenna 401m is located on the main surface 502 side of the lower right corner portion 553 of the battery-side case body 50.

The main antenna 401m extends from the feeding point 453 toward the right side surface 506, and further extends across a curved portion 506a of the right side surface 506 to a flat portion 506b of the right side surface 506. The main antenna 401m further extends from the flat portion 506b of the right side surface 506 to the curved lower right corner 523 of the battery-side case body 50, and is terminated at the point where an open end 401ma thereof reaches around the inflection point of the lower right corner 523. The open end 401ma of the main antenna 401m is located outboard with respect to the feeding point 453.

As described above, the open end 401ma of the main antenna 401m is located outboard with respect to the feeding point 453, and accordingly is less likely to be coupled to the ground plane in the apparatus case 4. This improves the performance of the main antenna 401m.

The main antenna 401m is disposed in such a manner that the main antenna 401m does not lie inboard with respect to the feeding point 453 and that the open end 401ma thereof is located outboard with respect to the feeding point 453. Thus, the main antenna 401m can be disposed nearer to the edge (nearer to the corner) in the electronic apparatus 1. Consequently, the main antenna 401m is less likely to be affected by the components in the apparatus case 4, and accordingly delivers improved performance.

### <Shape of Wireless LAN Antenna>

The wireless LAN antennas 405 and 406 that share the feeding point 454 are formed on an upper right corner portion 550 of the battery-side case body 50. The feeding point 454 is formed on the main surface 502 side of the upper right corner portion 550.

In one embodiment, the requisite performance for the wireless LAN antenna 406 in the 2.4 GHz frequency band is higher than the requisite performance for the wireless LAN antenna 405 in the 5 GHz frequency band. In particular, the signal loss acceptable for the wireless LAN antenna 406 in the 2.4 GHz frequency band is smaller than the signal loss acceptable for the wireless LAN antenna 405 in the 5 GHz frequency band.

The wireless LAN antenna 405 in the 5 GHz frequency band extends from the feeding point 454 toward the right side surface 506 to reach the curved boundary portion 526 between the main surface 502 and the right side surface 506, further extends through the boundary portion 526 toward the lower side surface 504, and is terminated. An open end 405a of the wireless LAN antenna 405 is located outboard with respect to the feeding point 454.

The wireless LAN antenna 406 in the 2.4 GHz frequency band extends from the feeding point 454 toward the right side surface 506 to reach the curved boundary portion 526 between the main surface 502 and the right side surface 506, and further extends through the boundary portion 526 toward the upper side surface 503. The wireless LAN antenna 406 is terminated at the point where an open end 406a thereof reaches around the inflection point of the curved upper right corner 520. The open end 406a of the wireless LAN antenna 406 is located outboard with respect to the feeding point 454.

As described above, in the battery-side case body 50, the wireless LAN antenna 406 in the 2.4 GHz frequency band is disposed nearer to the upper right corner 520 than the wireless LAN antenna 405 in the 5 GHz frequency band is, the wireless LAN antenna 406 being required to achieve relatively high requisite performance, the wireless LAN antenna 405 being required to achieve relatively low requisite performance. With the battery-side case body 50 being installed in the electronic apparatus 1, the wireless LAN antenna 406 is disposed nearer to the corner of the electronic apparatus 1 (nearer to the upper right corner of the electronic apparatus 1 assuming that the electronic apparatus 1 is seen from the cover member 31 side) than the wireless LAN antenna 405 is. Thus, the components in the electronic apparatus 1 are less likely to be situated in the vicinity of the wireless LAN antenna 406. This can regulate the deterioration of the performance of the wireless LAN antenna 406 due to the influence of the components in the apparatus case 4. Consequently, the high performance required of the wireless LAN antenna 406 can be achieved more easily.

Similarly, in a case where requisite performance is set for the wireless LAN antenna 406 in the 2.4 GHz frequency band but no requisite performance is set for the wireless LAN antenna 405 in the 5 GHz frequency band, the wireless LAN antenna 406 in the 2.4 GHz frequency band may be disposed nearer to the corner than the wireless LAN antenna 405 in the 5 GHz frequency band is. If this is the case, the requisite performance for the wireless LAN antenna 406 can be achieved more easily.

The open ends 405a and 406a of the wireless LAN antennas 405 and 406 are located outboard with respect to the feeding point 454, and accordingly are less likely to be coupled to the ground plane in the apparatus case 4. This can improve the performance of the wireless LAN antennas 405 and 406.

The wireless LAN antennas 405 and 406 are disposed in such a manner that the wireless LAN antennas 405 and 406 do not lie inboard with respect to the feeding point 454 and that the open ends 405a and 406a thereof are located outboard with respect to the feeding point 454, and thus the wireless LAN antennas 405 and 406 can be disposed nearer to the edge in the electronic apparatus 1.

Consequently, the wireless LAN antennas 405 and 406 are less likely to be affected by the components in the apparatus case 4, and accordingly deliver improved performance.

### <Shapes of Sub-antenna in 1.9 GHz Frequency Band and Sub-antenna in 800 MHz Frequency Band>

The sub-antenna 402s in the 1.9 GHz frequency band and the sub-antenna 403s in the 800 MHz frequency band that share the feeding point 452 are formed on the upper edge portion of the battery-side case body 50. The feeding point 452 is located on the main surface 502 side of the upper right corner portion 550 of the battery-side case body 50.

The sub-antenna 402s in the 1.9 GHz frequency band extends from the feeding point 452 toward the upper side surface 503, and further extends across a curved portion 503a of the upper side surface 503 to a flat portion 503b of the upper side surface 503. The sub-antenna 402s extends from the flat portion 503b of the upper side surface 503 to the curved upper right corner 520 of the battery-side case body 50, and is terminated at the point where an open end 402sa of the sub-antenna 402s goes slightly beyond the inflection point of the curved upper right corner 520. The sub-antenna 402s is formed on the upper right corner portion 550 of the battery-side case body 50. The open end 402sa of the sub-antenna 402s is located outboard with respect to the feeding point 452.

Meanwhile, the sub-antenna 403s in the 800 MHz frequency band extends from the feeding point 452 over a short distance toward the upper side surface 503, and then makes a 90-degree turn leftward to extend toward the left side surface 505. The sub-antenna 403s partially thickens on the way toward the left side surface 505, and is terminated at the point where an open end 403sa thereof reaches the upper left corner portion 551 of the battery-side case body 50. The open end 403sa of the sub-antenna 403s is located outboard with respect to the feeding point 452.

As described above, the open ends 403sa and 403sa of the sub-antennas 402s and 403s are located outboard with respect to the feeding point 452, and accordingly are less likely to be coupled to the ground plane in the apparatus case 4. This improves the performance of the sub-antennas 402s and 403s.

The sub-antennas 402s and 403s are disposed in such a manner that the sub-antennas 402s and 403s do not lie inboard with respect to the feeding point 452 and that the open ends 402sa and 403sa thereof are located outboard with respect to the feeding point 452. Thus, the sub-antennas 402s and 403s can be disposed nearer to the edge in the electronic apparatus 1. Consequently, the sub-antennas 402s and 403s are less likely to be affected by the components in the apparatus case 4, and accordingly deliver improved performance.

Although the antennas that share the feeding points with the GPS antennas 104 and 404 are the antennas that perform only reception in the above-mentioned embodiments 1 and 2, these antennas may be antennas that perform only transmission or antennas that perform transmission and reception. In this case as well, the GPS antennas 104 and 404 are disposed nearer to the corners of the electronic apparatus 1 than the antennas that share the feeding points with the GPS antennas 104 and 404 are, and accordingly the GPS antennas 104 and 404 can deliver improved performance.

In the above-mentioned examples, the GPS antennas 104 and 404 are used. Alternatively, antennas that can receive signals from a satellite in another satellite positioning system may be included. For example, an antenna that can receive signals from a satellite in the Global Navigation Satellite System (GLONASS) may be included. Still alternatively, an antenna that can receive signals from satellites in a plurality of satellite positioning systems may be included. For example, an antenna that can receive signals from a satellite in GPS and a satellite in GLONASS may be included. In this case as well, the relevant antenna is disposed nearer to a corner in the electronic apparatus 1, and accordingly the relevant antenna can deliver improved performance.

Although embodiments of the present disclosure have been applied to mobile phones in the above description, embodiments of the present disclosure are also applicable to electronic apparatuses other than the mobile phones including antennas.

While the electronic apparatus 1 has been described above in detail, the above description is in all aspects illustrative and not restrictive. In addition, various modifications described above are applicable in combination as long as they are not mutually inconsistent. It is understood that numerous modifications which have not been exemplified can be devised without departing from the scope of the present disclosure.

1. An electronic apparatus comprising:
a first receiving antenna that receives a signal from a satellite in a satellite positioning system;
a multi-antenna including a second receiving antenna; and
a first feeding point shared by the first and second receiving antennas, wherein
the first receiving antenna is located nearer to a corner of the electronic apparatus than the second receiving antenna is.

2. The electronic apparatus according to claim 1, wherein
at least one of an open end of the first receiving antenna and an open end of the second receiving antenna is located outboard with respect to the first feeding point.

3. The electronic apparatus according to claim 1, wherein
a frequency band of a wireless signal received by the second receiving antenna is lower than a frequency band of a wireless signal received by the first receiving antenna, and
the second receiving antenna is located in such a manner that the second receiving antenna lies inboard with respect to the first feeding point and that an open end of the second receiving antenna is located outboard with respect to the first feeding point.

4. The electronic apparatus according to claim 1, wherein
a frequency band of a wireless signal received by the second receiving antenna is higher than a frequency band of a wireless signal received by the first receiving antenna, and
the second receiving antenna is located in such a manner that the second receiving antenna does not lie inboard with respect to the first feeding point and that an open end of the second receiving antenna is located outboard with respect to the first feeding point.

5. The electronic apparatus according to claim 1 comprising:
a third antenna;
a fourth antenna that is required to achieve requisite performance higher than requisite performance set for the third antenna; and
a second feeding point shared by the third and fourth antennas, wherein
the fourth antenna is located nearer to a corner of the electronic apparatus than the third antenna is.
